(19) United States
(12) Patent Application Publication
(10) Pub. No.: US 2021/0003303 A1
(43) Pub. Date: Jan. 7, 2021

(54) ULTRASONIC HUMIDIFIER FOR REGULATING HUMIDITY IN AN ENVIRONMENT

(71) Applicant: Shenzhen Tokyun Technology Co., Ltd., Shenzhen (CN)

(72) Inventors: Xiyan Ouyang, Shenzhen (CN); Ruiwei Wu, Shenzhen (CN)

(73) Assignee: Shenzhen Tokyun Technology Co., Ltd., Shenzhen (CN)

(21) Appl. No.: 16/802,533

(22) Filed: Feb. 26, 2020

(30) Foreign Application Priority Data
Jul. 2, 2019 (CN) 201921017443.6

(51) Int. Cl. F24F 11/00; F24F 6/12; B05B 17/06

(52) U.S. Cl. CPC F24F 11/0008; B05B 17/0615; F24F 6/12

(57) ABSTRACT

Embodiments of the disclosure provide humidifiers and methods for regulating a humidity in an environment using the humidifiers. An exemplary humidifier may include a water tank configured to store a supply of water and a chamber in fluid communication with the water tank. The chamber may be configured to receive the supply of water. The humidifier may also include a mist generator disposed in the chamber and configured to generate a mist of water droplets from the supply of water. The humidifier may also include a tube in fluid communication with the chamber to direct the mist of water droplets to flow from the chamber to an exterior space through an outlet of the humidifier. The humidifier may further include a mist accelerator disposed in proximity to the outlet and configured to generate a forced air flow to accelerate the mist of water droplets flowing out from the outlet.

### CROSS-REFERENCE TO RELATED APPLICATION

The present application claims the benefits of priority to Chinese Utility Model Application No. 201921017443.6, filed Jul. 2, 2019, the entire contents of which are expressly incorporated herein by reference.

### TECHNICAL FIELD

The present disclosure generally relates to a device for regulating humidity in an environment, and more particularly to an improved humidifier having a mist accelerator to accelerate a mist of water droplets generated by the humidifier.

### BACKGROUND

A conventional ultrasonic humidifier generates a water mist using an ultrasonic transducer disposed at the bottom of a base of the humidifier. The ultrasonic transducer vibrates at a high frequency (e.g., ultrasonic frequency) to generate the water mist, which then flows out of the humidifier into its surroundings through a duct.

Such a conventional ultrasonic humidifier has long suffered the short-range problem because the water mist cannot reach beyond a few feet from the humidifier. This is partly due to the resistance present on the surface of the duct and the shape of the duct (e.g., including turns and/or corners), both slowing down the water mist while it is traveling through the duct. As a result, the speed of the water mist flowing out of the humidifier is quite low, and most of the mist would fall within the vicinity of the humidifier. This short-range problem greatly diminishes the effectiveness of the humidifier. Moreover, a large amount of the fallen water droplets would accumulate and dampen the floor, furniture, and even electronic devices nearby, posing serious safety concerns.

Embodiments of the disclosure address the above-discussed problems by an improved humidifier using a mist accelerator to accelerate the mist generated by the humidifier, thereby improving the range and enhancing the effectiveness of the humidifier.

### SUMMARY

In one example, embodiments of the disclosure provide a humidifier. An exemplary humidifier may include a water tank configured to store a supply of water and a chamber in fluid communication with the water tank. The chamber may be configured to receive the supply of water. The humidifier may also include a mist generator disposed in the chamber and configured to generate a mist of water droplets from the supply of water. The humidifier may also include a tube in fluid communication with the chamber to direct the mist of water droplets to flow from the chamber to an exterior space through an outlet of the humidifier. The humidifier may further include a mist accelerator disposed in proximity to the outlet and configured to generate a forced air flow to accelerate the mist of water droplets flowing out from the outlet.

In another example, embodiments of the disclosure provide an ultrasonic humidifier. An exemplary ultrasonic humidifier may include a water tank configured to store water and a cover removably disposed above the water tank to allow refilling of the water tank. The ultrasonic humidifier may also include a chamber in fluid communication with the water tank and configured to receive a supply of water. The ultrasonic humidifier may also include an ultrasonic transducer disposed in the chamber configured to generate a mist of water droplets from the supply of water. The ultrasonic humidifier may further include a tube in fluid communication with the chamber to direct the mist of water droplets to flow from the chamber to an exterior space through an outlet disposed on the cover. In addition, the ultrasonic humidifier may include a fan disposed on the cover configured to generate an air flow to accelerate the mist of water droplets flowing out from the outlet.

In a further example, embodiments of the disclosure provide a method for regulating a humidity in an environment using a humidifier. An exemplary method may include providing a supply of water in a chamber of the humidifier and generating a mist of water droplets from the supply of water in the chamber using an ultrasound transducer. The method may also include directing the mist of water droplets from the chamber to the environment exterior to the humidifier through an outlet of the humidifier. The method may further include accelerating the mist of water droplets flowing out from the outlet using a forced air flow generated by a mist accelerator disposed in proximity to the outlet.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates an exemplary humidifier for regulating humidity of an environment, according to embodiments of the disclosure.

FIG. 2 illustrates the exemplary humidifier with an explosive view of the cover, according to embodiments of the disclosure.

FIG. 3 illustrates an explosive view of the exemplary humidifier, according to embodiments of the disclosure.

FIG. 4 illustrates another exemplary humidifier for regulating humidity of an environment, according to embodiments of the disclosure.

FIG. 5 is a flowchart of an exemplary method for regulating humidity in an environment using a humidifier, according to embodiments of the disclosure.

FIG. 6 is a flowchart of another exemplary method for regulating humidity in an environment using a humidifier, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

Humidifiers have been widely used for regulating humidity of an environment within a limited space such as a room, a garage, or a storage room. For example, water molecules may be released into the environment through evaporation, heat, or ultrasonic energy by a respective type of humidifiers. Among the different types, ultrasonic humidifiers have gained popularity due to their compact size and silent operation. A typical ultrasonic humidifier usually has a water tank to hold water and an ultrasonic transducer to break down the water into small droplets. The droplets then form a water mist that flows out of the humidifier and into the environment to increase the humidity.

While conventional ultrasonic humidifiers can provide instant water mists, they suffer the short-range problem. Most of the generated water droplets accumulate and fall within a short distance from the humidifiers. This is because the velocity of the water mist generated by such a conventional ultrasonic transducer is relatively low when the water mist exits the humidifier. For example, after the water mist is formed, it travels through the inner structure of the humidifier, which may have a relatively large elevation (e.g., from the water surface where the water mist is formed to the exist point of the humidifier) and/or a non-straight path (e.g., presence of turns and/or corners). As a result, the water mist may be slowed down significantly when it exits the humidifier. Without the needed velocity, small water droplets in the mist would cluster, forming larger droplets and eventually falling onto the ground or the surface of nearby objects. In general, the further the mist can reach, the more effective the humidifier can be at regulating the humidity of the environment, and vice versa. This accumulation of large water droplets in close range may also dampen the nearby object, even causing safety issues when electrical apparatuses are present.

The present application discloses improved humidifiers addressing the short-range problem by accelerating the water mist flowing out of a humidifier using a forced air flow generated by a mist accelerator. For example, the mist accelerator may be in the form of a fan disposed on a cover of the humidifier, close to an outlet from which the water mist exists the humidifier. In this way, the water mist can be accelerated after exiting the humidifier, reaching higher and/or farther areas in an environment of the surroundings than those achievable by conventional humidifiers. As a result, the improved humidifiers disclosed herein can provide enhanced capabilities at regulating the humidity of the environment.

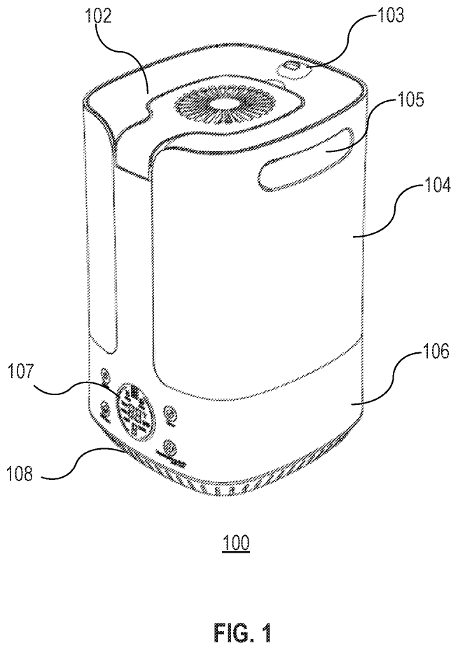

FIG. 1 illustrates an exemplary humidifier 100 for regulating the humidity of an environment, according to embodiments of the disclosure. As illustrated in FIG. 1, humidifier 100 may include a cover 102, a water tank 104 (also serves as an upper body of humidity 100), a lower body 106, and a base 108. In some embodiments, cover 102 may be disposed above water tank 104. For example, cover 102 may include an arc-shaped profile at the bottom that fits in an inner bore of water tank 104 around at least a portion of an inner circumferential profile of water tank 104. The inner bore of water tank 104 may extend from the bottom of cover 102 to the top of lower body 106. Water tank 104 may be disposed on top of lower body 106 and configured to store water. In some embodiments, the outside of water tank 104 may have a substantially cylindrical profile, a substantially rectangular profile, a substantially hexagonal profile, etc. Lower body 106 may have substantially the same outside profile as water tank 104. Lower body 106 may be disposed above base 108.

In some embodiments, cover 102 may include an outlet 103 to allow a mist of water droplets generated by humidifier 100 to exit and flow to the exterior space away from humidifier 100. For example, outlet 103 may be in a form of a nuzzle that has a relatively narrow passage through which the mist of water droplets can flow out. Outlet 103 may be made from a metal material (e.g., stainless steel, aluminum alloy, etc.), a plastic material, or other suitable materials. Outlet 103 may be in the form of an atomizing nozzle, a cleanable anti-drip mist spray nozzle, a humidifying nozzle, or any suitable structure allowing passage of the mist of water droplets. In some embodiments, outlet 103 may be configured to control the direction and/or characteristics of the mist of water droplets as it exits humidifier 100. For example, outlet 103 may be angularly disposed with respect to the upper surface of cover 102 to direct the mist of water droplets to a particular direction.

In some embodiments, water tank 104 may include a recess that forms a handle 105 to allow water tank 104, as well as any component(s) above water tank 104 (e.g., cover 102) to be detached from lower body 106. For example, handle 105 may be part of the inner bore of water tank 104 that extends to the outside surface of water tank 104.

In some embodiments, lower body 106 may include a control panel 107 disposed on an outside surface of lower body 106. As shown in FIG. 1, control panel 107 may include control buttons such as a power control button, a timer, mist level control buttons, a sleeping mode control button and the like. The control buttons may be configured to receive inputs including humidity regulating parameters such as a target humidity level, instructions such as turning on/off humidifier 100, a duration of the timer, etc. Control panel 107 may further include a display pad configured to display information including operating parameters (e.g., the on/off state, timer information, the level of mist, the operating mode, etc.) and environmental parameters (e.g., the humidity level and/or the temperature of the environment, etc.). It is contemplated that the control buttons and the information displayed on the display pad are not limited to the examples disclosed above. Other control buttons and information may also be used that are suitable for a particular application scenario (e.g., used in an automobile, a living room, a storage room, a pet cage, etc.).

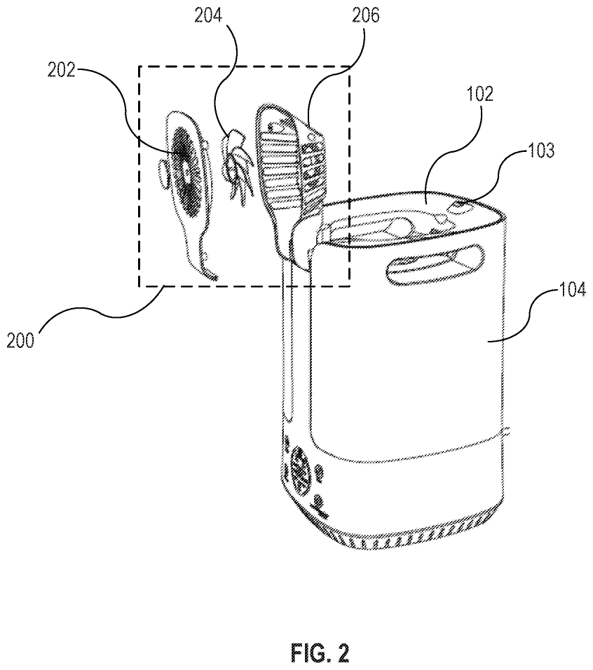

FIG. 2 illustrates the exemplary humidifier with an explosive view of the cover, according to embodiments of the disclosure. As illustrated in FIG. 2, a mist accelerator 204 is disposed between a cover pad 202 and a mist accelerator holder 206. Mist accelerator 204, cover pad 202, and mist accelerator holder 206 may collectively form a mist accelerator assembly 200.

In some embodiments, cover pad 202 may cover at least a portion of the top surface of cover 102. For example, cover pad 202 may include patterned holes that allow air flow to pass through. In some embodiments, the patterned holes on cover pad 202 may be patterned for facilitating the air flow to flow out from mist accelerator assembly 200 while providing an exterior protection to mist accelerator 204. In some embodiments, cover pad 202 may be configured to protect a child from accidentally touching the spinning part of mist accelerator 204.

Mist accelerator 204 may be in the form of a fan disposed corresponding to a center portion of the patterned holes of cover pad 202. Mist accelerator 204 may include at least one blade driven by a motor for generating a forced air flow. The at least one blade may have a turbine blade shape. When the at least one blade is driven by the motor to rotate/spin, air may be drawn from one side to another side of mist accelerator 204, thereby generating the forced air flow.

In some embodiments, mist accelerator holder 206 may be disposed within an inner bore of cover 102 and configured to hold mist accelerator 204 and provide support to cover pad 202. For example, mist accelerator holder 206 may have a basket shape that can allow an air flow (e.g., the forced air flow generated by the blade(s) of mist accelerator 204) to pass through while holding (e.g., providing support to) mist accelerator 204. In some embodiments, the upper edge of the basket-shaped mist accelerator holder 206 may provide support to cover pad 202. For example, the upper edge may form a rim on which cover pad 202 can sit. Mist accelerator 204 may be disposed within the cavity defined by cover pad 202 and mist accelerator holder 206.

In some embodiments, mist accelerator holder 206 may be configured to rotate open to be partially detached from cover 102. For example, mist accelerator holder 206 may be connected to cover 102 through an axle (not shown), passing through the edge of mist accelerator holder 206. The axle is fixed to edges of cover 102 such that mist accelerator holder 206 can rotate about the axle to provide a displacement (e.g., an opening) between mist accelerator holder 206 and cover 102. The opening may be used for refilling water into water tank 104.

In some embodiments, mist accelerator 204 is disposed in proximity to outlet 105 such that the forced air flow generated by mist accelerator 204 may accelerate the mist of water droplets exiting outlet 105. In some embodiments, the mist of water droplets may flow out from outlet 105 in a first direction. The first direction may be defined by the physical configuration of outlet 105. For example, when outlet 105 includes a nozzle, the direction to which the nozzle points to may be defined as the first direction. The first direction may also be defined by a tube (to be discussed in greater detail below) to which outlet 105 is connected. For example, the direction to which the tube extends may be defined as the first direction. The first direction may further be defined by the mist of water droplets, which flows out of outlet 105 toward the first direction due to its inertia. The forced air flow generated by mist accelerator 204 may flow in a second direction. The second direction may be defined or determined by the configuration of mist accelerator 204. For example, when mist accelerator 204 takes the form of a fan with one or more blades, the direction perpendicular to the surface of the rotation surface of the blade(s) may be defined as the second direction. In some embodiments, the first direction and the second direction can be substantially parallel to each other. For example, the mist of water droplets may flow out of outlet 103 in an upward direction (e.g., substantially perpendicular to the upper surface of top 102, and the forced air flow generated by mist accelerator 204 may also flow in the upward direction when mist accelerator assembly 200 is in a closed position (e.g., when mist accelerator holder 206 sits on top or fits within the recess/inner bore of top 102). In this closed position, mist accelerator 204 may generate the force air flow that flows upward, accelerating the nearby mist of water droplets also flowing upward. The velocity of the mist of water droplets can be increased to reach a higher elevation. In another example, the mist of water droplets may flow out of outlet 103 angularly (e.g., in about 45-degree angle relative to the upper surface of top 102), and mist accelerator assembly 200 may also be angularly positioned with a similar angle. This can be achieved by, for example, rotating mist accelerator assembly 200 about halfway toward the closed position from the open position shown in FIG. 2. A position holding mechanism (e.g., using pins, locks, friction, etc.) may be used to maintain the position of mist accelerator assembly 200. The force air flow generated by mist accelerator 204 may flow from the bottom of mist accelerator holder 206 toward cover pad 202. In this way, the mist of water droplets may be drawn into mist accelerator assembly 200 from the bottom of mist accelerator holder 206 by the force air flow, and then pushed out from cover pad 202 with increased velocity. The accelerated mist may reach higher elevation and farther distance then those reachable by conventional humidifiers.

In some embodiments, the first direction may traverse the second direction. For example, the mist of water droplets may flow along an angular direction (e.g., at about 45-degree angles relative to the upper surface of top 102), while the forced air flow may flow upward (e.g., when mist accelerator assembly 200 is in the closed position). In this way, almost the entirety of the mist of water droplets exiting outlet 103 can be accelerated by the forced air flow without passing through the components of accelerator assembly 200. Because the direction of the mist prior to being accelerated and the direction of the forced air flow are not in parallel, the direction of the mist may change upon acceleration by the forced air flow.

In some embodiments, the direction of the mist and the direction of the forced air flow may traverse each other at a predetermined angle. For example, a nozzle disposed at outlet 103 may be configured to direct the mist flowing out from outlet 103 toward mist accelerator 204 or the air path of the forced air flow generated by mist accelerator 204. The nozzle may be positioned at a predetermined angle relative to the upper surface of cover 102. The direction of the forced air flow can also be adjusted in a continuous or stepped manner. For example, mist accelerator assembly 200 may be rotated continuously or in a stepped manner between the closed position and the open position, thereby changing the direction of the forced air flow generated by mist accelerator 204 disposed within the cavity formed by mist accelerator holder 206 and cover pad 202. In this way, one or more predetermined angles between the direction of the mist and the direction of the forced air flow can be set by controlling the angular positions of the nozzle disposed at outlet 103 and/or mist accelerator assembly 200.

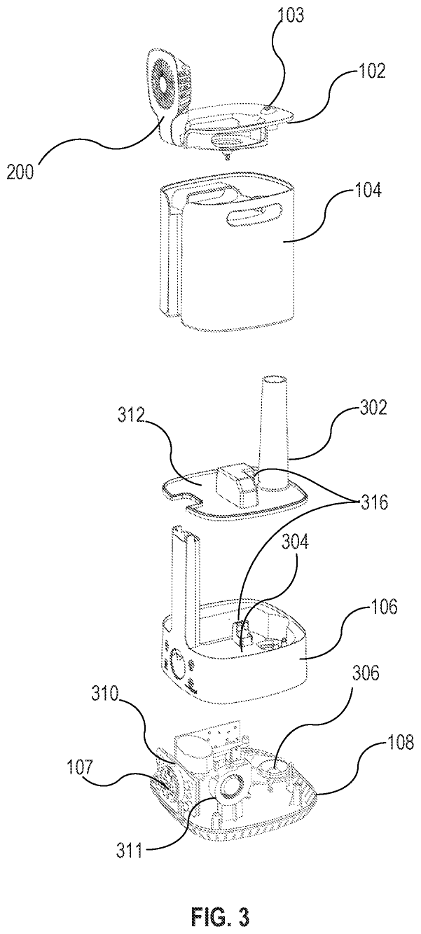

FIG. 3 illustrates an explosive view of humidifier 100, according to embodiments of the disclosure. As illustrated in FIG. 3, humidifier 100 may further include a tube 302 disposed on a separator 312, a chamber 304, a mist generator 306, a control unit 310, and a fan 311 disposed on base 108. In some embodiments, separator 312 is disposed on top of lower body 106 and may be configured to separate water tank 104 and lower body 106. In some embodiments, tube 302 may be integrated with separator 312 and may extend from the bottom side of separator 312 to outlet 103 through an internal passage of water tank 104. In some embodiments, tube 302 may include a substantially cylindrical profile, a substantially rectangular profile, a substantially hexagonal profile, etc. for directing the mist of water droplets from chamber 304 to outlet 103. In some embodiments, the top end of tube 302 may be connected with the bottom profile of cover 102. Outlet 103 may include a section of tube extending toward tube 302. The diameter of the section of the tube may be smaller than the diameter of tube 302 such that tube 302 may sleeve over the section of the tube to stop the water and/or mist of water droplets from exiting or entering tube 302 from the connection between outlet 103 and tube 302.

In some embodiments, water tank 104 may have a shape fitting the top profile of separator 312, the bottom profile of cover 102, and the profile of tube 302. Water tank 104 may be configured to store a supply of water. In some embodiments, water tank 104 may be filled through a hole on the bottom of cover 102. For example, mist accelerator assembly 200 may be partially opened to uncover the hole on the bottom of cover 102. Water may be filled through the hole and stored in water tank 104. In some embodiments, cover 102 may be detached from water tank 104, and water tank 104 may be filled directly from an opening on the top portion of water tank 104.

In some embodiments, chamber 304 may be in fluid communication with water tank 104 and may be configured to receive the supply of water from water tank 104. For example, chamber 304 may be fluid connected to water tank 104 through cartridge 316 such that water would flow into chamber 304 through cartridge 316 when water tank 104 engages cartridge 316. In some embodiments, cartridge 316 may be a demineralization cartridge and configured to demineralize the water being supplied to chamber 304.

In some embodiments, mist generator 306 may include an ultrasonic transducer for generating the mist of water droplets. For example, mist generator 306 may be disposed in chamber 304 and configured to vibrate at an ultrasonic frequency (e.g., using the ultrasonic transducer) to convert water into the mist of water droplets. In some embodiment, mist generator 306 may be electrically connected to control unit 310 on base 108 and reach chamber 304 through an opening at the bottom of chamber 304. The interface between mist generator 306 and the edge of the opening may be sealed to be waterproof to prevent leaking of water into base 108. The generated mist of water droplets may flow into tube 302, which may further direct the mist to flow from chamber 304 to an exterior space through outlet 103. In some embodiments, the mist generated by mist generator 306 may be pushed by a fan 311 into tube 302 and toward outlet 103.

In some embodiments, control unit 310 may be disposed on base 108. For example, control unit 310 may be configured to receive an input (e.g., operating parameters, instructions, target value, etc.) through control panel 107 and generate parameters for displaying on control panel 107. Control unit 310 may also be configured to control the operation of mist accelerator 204 based on the humidity level of the environment. For example, humidifier 100 may include at least one humidity sensor configured to detect a humidity level in the environment around humidifier 100. The at least one humidity sensor may be disposed on humidifier 100 or located remotely but communicatively coupled to control unit 310. The at least one humidity sensor may generate a signal indicating the humidity level (e.g., convert the humidity level into an electrical signal). Control unit 310 may include a controller (e.g., a microprocessor or any suitable processing unit) communicatively coupled to the humidity sensor. The controller may receive the signal generated by the at least one humidity sensor and control humidifier 100 based on the signal. For example, the controller may be configured to control the operation of mist accelerator 204 by, for example, adjusting the direction and/or the intensity of the forced air flow generated by mist accelerator 204. The controller may also be configured to adjust the intensity of the mist generated by mist generator 306 and/or the intensity of the air flow generated by fan 311. In some embodiments, the controller may control mist accelerator 204 and/or mist generator 306 based on the determination made by the controller.

In some embodiments, the determination may include whether the humidity level of the environment is lower than a threshold. For example, a user may set a target humidity level (e.g., 65%) using buttons on control panel 107. The threshold humidity level may be set as the target humidity level set by the user (i.e., 65% in this example). When the signal generated by the humidity sensor indicates that the humidity level is lower than the threshold, control unit 310 may control mist accelerator 204 and/or mist generator 306 to adjust/regulate the humidity level in the environment. For example, control unit 310 may increase the intensity of the mist generated by mist generator 306 and/or the intensity of the forced air flow generated by mist accelerator 204.

It is contemplated that other parameters such as the temperature of the environment may also be detected and used for regulating the humidity. For example, humidity level may depend on the temperature of the environment. Control unit 310 may include or may communicate with one or more temperature sensors (e.g., thermal detectors) to obtain temperature information. Control unit 310 may then regulate the humidity based on the temperature information. As described above, humidity regulation may include adjusting the intensity of the forced air flow generated by mist accelerator 204 (e.g., adjusting the speed of the fan) and/or the intensity of the mist generated by mist generator 306 (e.g., adjusting the power applied to the ultrasound transducer). This may create a feed-back control loop to constantly monitor the key parameters of the environment and regulate the humidity level based on the monitoring result.

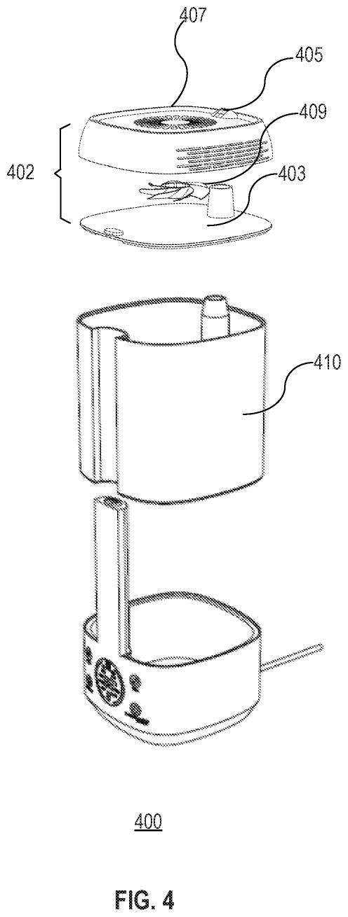

FIG. 4 illustrates another exemplary humidifier 400 for regulating humidity of an environment, according to embodiments of the disclosure. Humidifier 400 has similar components to those of humidifier 100 except a different cover 402. Therefore, detailed description of similar components, such as the water tank, chamber, mist generator (e.g., ultrasound transducer), tube, and base are omitted. As illustrated in FIG. 4, cover 402 may be a stand-alone assembly that is removably disposed above a water tank 410. Cover 402 can be completely detached or removed from water tank 410 to allow refilling of the water tank. Cover 402 may include a mist accelerator holder 403, a cover pad 407, and a mist accelerator 409. Mist accelerator 409 may be disposed within the cavity defined by mist accelerator holder 403. Mist accelerator 409 may include or take the form of a fan to generate a forced air flow for accelerating a mist of water droplets generated by humidifier 400 that flows out of outlet 405, similar to mist accelerator 204.

Consistent with the disclosure herein, cover pad 407 may include patterned holes to allow the forced air flow generated by mist accelerator 409 to exit. Cover pad 407 may also include an outlet 405 (e.g., a nuzzle) for the mist of water droplets to flow out of humidifier 400. In some embodiments, the patterned holes may be in proximity to outlet 405 such that the mist flowing out from outlet 405 may be accelerated by the forced air flow generated by mist accelerator 409. Cover pad 407 may protect mist accelerator 409 from exterior disturbance (e.g., preventing outside objects from contacting rotators/spinners of mist accelerator 409 while mist accelerator 409 is operating).

In some embodiments, mist accelerator 409 may be disposed on mist accelerator holder 403. Similar to mist accelerator 204, mist accelerator 409 may include a fan disposed corresponding to a center portion of the patterned holes of cover pad 407. Mist accelerator 409 may include at least one blade driven by a motor for generating a forced air flow. For example, the at least one blade may have a turbine blade shape. When driven by the motor to rotate/spin, air may be drawn from one side to another side of the fan.

In some embodiments, cover 402 may be removable from humidifier 400 to allow filling of water into water tank 410. For example, cover 402 may be completely removed from humidifier 400 and water can be refilled to water tank 410 directly from the top opening.

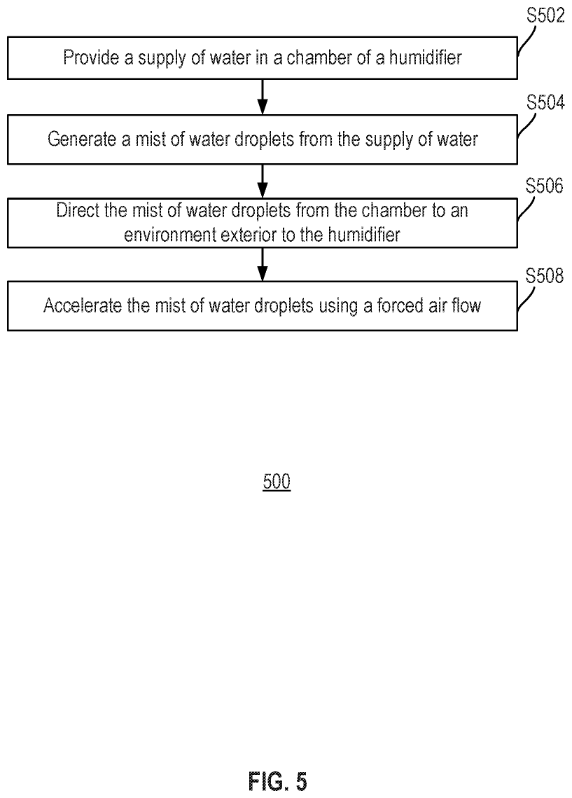

FIG. 5 illustrates a flowchart of an exemplary method 500 for regulating the humidity level in an environment using a humidifier, according to embodiments of the disclosure. In some embodiments, method 500 may be implemented by humidifier 100 or 400. Method 500 may include steps S502-S508 as described below. It is to be appreciated that some of the steps may be optional. Further, some of the steps may be performed simultaneously, or in a different order than shown in FIG. 5.

In step 502, a water tank (e.g., water tank 104/410) may provide a supply of water to a chamber (e.g., chamber 304) of humidifier 100/400. In some embodiments, the chamber may be in fluid communication with the water tank and is configured to receive the supply of water from the water tank. For example, the chamber may be connected to the water tank through a cartridge (e.g., cartridge 316) such that water would flow into the chamber through the cartridge. In some embodiments, the cartridge may be a demineralization cartridge and configured to demineralize the water being supplied to the chamber.

In step S504, a mist of water droplets may be generated by a mist generator (e.g., mist generator 306) from the supply of water provided by the water tank. In some embodiments, the mist generator may include an ultrasonic transducer, which may vibrate at an ultrasonic frequency to nebulize the water to generate the mist of water droplets.

In step S506, the mist of water droplets may be directed by a tube (e.g., tube 302) from the chamber to an environment exterior to the humidifier. For example, after the mist generator generates the mist of water droplets, the mist may flow into the tube. In some embodiments, the mist may be pushed into the tube by a fan (e.g., fan 311) disposed on the base (e.g., base 108) of humidifier 100/400. The mist of water droplets may flow upward along the tube toward an outlet (e.g., outlet 103/405) that connects to the tube. The mist of water droplets may then exit humidifier 100/400 and flow into the environment through the outlet.

In step S508, the mist of water droplets flowing out of humidifier 100/400 through the outlet may be accelerated by a forced air flow generated by a mist accelerator (e.g., mist accelerator 204/409). The mist accelerator may include a fan with at least one blade driven by a motor for generating the forced air flow. In some embodiments, the mist accelerator may be disposed in proximity to the outlet, thereby enhancing the effectiveness of accelerating the mist. In some embodiments, the position of the mist accelerator may be adjusted to change the direction of the forced air flow. For example, the direction of the forced air flow may be parallel to the direction of the mist. In this case, the mist accelerator may either draw the mist toward the mist accelerator or push the mist away from the mist accelerator. In another example, the direction of the forced air flow may traverse the direction of the mist. This may keep the mist accelerator from contacting the mist, thereby protecting its mechanical and/or electrical components from the moisture of the mist.

Accelerating the mist of water droplets outside the humidifier using a mist accelerator disposed in proximity to the outlet has many advantages. For example, the direction of the forced air flow can be adjusted as needed to direct the accelerated mist to a desirable place in the environment. In addition, the mist accelerator is easy to clean, maintain, and replace. Compared to placing the mist accelerator inside the humidifier to accelerate the mist prior to existing the outlet, using the mist accelerator to accelerate the mist flowing outside the outlet is more effective. This is because the outlet normally imposes resistance to the mist flowing therethrough, significantly reducing the velocity of the mist and making the acceleration of the mist prior to its existing the outlet less effective.

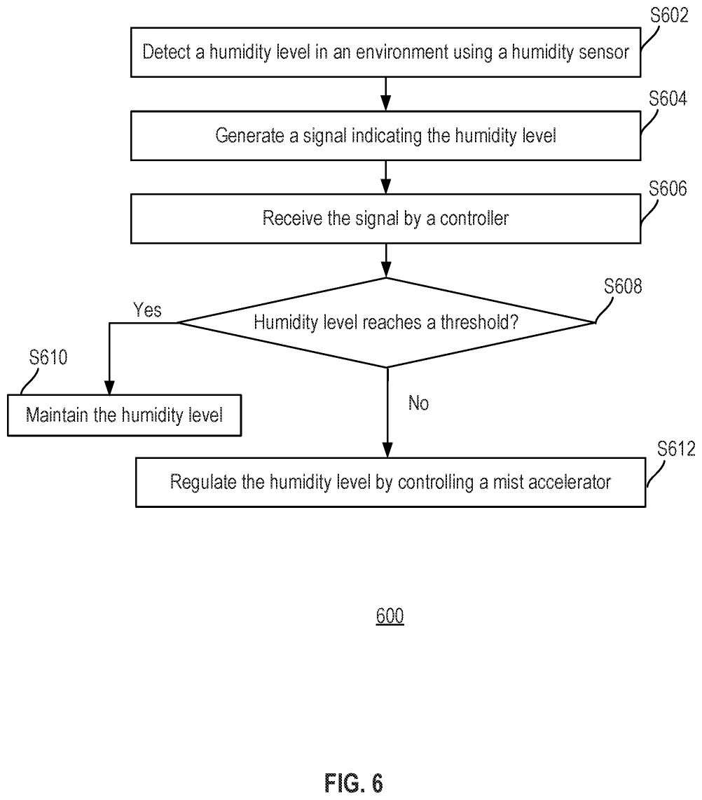

FIG. 6 illustrates a flowchart of an exemplary method 600 for regulating the humidity level in an environment, according to embodiments of the disclosure. Method 600 may be implemented by humidifier 100 or 400. Method 600 may include steps S602-S612 as described below. It is to be appreciated that some of the steps may be optional. Further, some of the steps may be performed simultaneously, or in a different order than shown in FIG. 6.

In step S602, one or more humidity sensors may detect the humidity level in an environment. As discussed above, the one or more humidity sensors may be disposed on humidifier 100/400 or located remotely and communicatively linked to humidifier 100/400. In some embodiments, placing a humidity sensor remotely with respect to the humidifier may provide a more accurate measurement result because the humidity level tends to be much higher in areas closer to the humidifier due to the short-range problem typical to ultrasonic humidifiers.

In step S604, the humidity sensor may generate a signal indicative of the humidity level of the environment. For example, the humidity sensor may convert the detected humidity level into an electrical signal indicative of the humidity level of the environment.

In step S606, a control unit (e.g., control unit 310) of humidifier 100/400 may receive the signal. For example, the control unit may be communicatively connected to the humidity sensor to receive the signal through wired or wireless connection. In step S608, the control unit may determine if the humidity level reaches a threshold. For example, the control unit may first determine the humidity level based on the signal, and then compare the humidity level with the threshold. In another example, the control unit may compare the signal directly with a threshold that is related to a target humidity level. In yet another example, the control unit may first convert the received signal into an intermediate signal (not necessarily the actual humidity level) and then compare the intermediate signal with a threshold signal that is related to a target humidity level. In some embodiments, a user may set the target humidity level (e.g., 50%, 55%, 60%, 65%, 70%, etc.) through buttons of a control panel (e.g., control panel 107). The target humidity level may be used as the threshold or used to derive a threshold.

When the control unit determines that the detected humidity level reaches the threshold, method 600 proceeds to step S610, in which the control unit may maintain the humidity level. For example, the control unit may control the humidifier to keep the current working status of regulating the humidity of the environment or may reduce the power output to the mist generator and/or the mist accelerator to save energy.

On the other hand, when the control unit determines that the detected humidity level does not reach the threshold, then method 600 proceeds to step 5612, in which the control unit may control a mist accelerator (e.g., mist accelerator 204/409) to regulate (e.g., increase) the humidity level. For example, the control unit may adjust the direction and/or the intensity of the forced air flow generated by the mist accelerator. In some embodiments, when the mist accelerator includes a fan, the control unit may increase the speed of the fan to improve the effectiveness of regulating the humidity in the environment. In some embodiments, the control unit may adjust the direction of the forced air flow to direct the mist of water droplets toward a particular direction that require an increase of the humidity level.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A humidifier, comprising:
a water tank configured to store a supply of water;
a chamber in fluid communication with the water tank and configured to receive the supply of water;
a mist generator disposed in the chamber and configured to generate a mist of water droplets from the supply of water;
a tube in fluid communication with the chamber to direct the mist of water droplets to flow from the chamber to an exterior space through an outlet of the humidifier; and
a mist accelerator disposed in proximity to the outlet and configured to generate a forced air flow to accelerate the mist of water droplets flowing out from the outlet.

2. The humidifier of claim 1, wherein:
the outlet is configured to direct the mist of water droplets flowing out from the outlet in a first direction; and
the mist accelerator is configured to generate the forced air flow to flow in a second direction.

3. The humidifier of claim 2, wherein the first direction is substantially parallel to the second direction.

4. The humidifier of claim 2, wherein the first direction traverses the second direction.

5. The humidifier of claim 4, wherein the first direction traverses the second direction at a predetermined angle.

6. The humidifier of claim 2, wherein the mist accelerator is movably disposed in proximity to the outlet to allow adjustment of the second direction.

7. The humidifier of claim 1, wherein the mist accelerator includes a fan to generate the forced air flow.

8. The humidifier of claim 7, wherein the fan is configured to draw the mist of water droplets flowing out from the outlet toward the fan.

9. The humidifier of claim 7, wherein the fan is configured to push the mist of water droplets flowing out from the outlet away from the fan.

10. The humidifier of claim 7, wherein:
the fan includes at least one blade in a center portion of the fan to generate the forced air flow.

11. The humidifier of claim 1, comprising:
a humidity sensor configured to detect a humidity level in an environment around the humidifier and generate a signal indicating the humidity level; and
a controller communicatively coupled to the humidity sensor and configured to:
receive the signal indicating the humidity level;
determine whether the humidity level reaches a threshold based on the signal; and
control the mist accelerator to adjust the forced air flow based on the determination.

12. An ultrasonic humidifier, comprising:
a water tank configured to store water;
a cover movably disposed above the water tank to allow refilling of the water tank;
a chamber in fluid communication with the water tank and configured to receive a supply of water;
an ultrasonic transducer disposed in the chamber and configured to generate a mist of water droplets from the supply of water;
a tube in fluid communication with the chamber to direct the mist of water droplets to flow from the chamber to an exterior space through an outlet disposed on the cover;
a fan disposed on the cover and configured to generate an air flow to accelerate the mist of water droplets flowing out from the outlet.

13. The ultrasonic humidifier of claim 12, comprising a nozzle disposed at the outlet and configured to direct the mist of water droplets flowing out from the outlet toward the fan.

14. The ultrasonic humidifier of claim 12, wherein the fan is angularly disposed on the cover to generate the air flow that flows along a first direction that is non-perpendicular to a horizontal plane.

15. The ultrasonic humidifier of claim 14, wherein a position of the fan is adjustable to adjust the first direction.

16. The ultrasonic humidifier of claim 15, wherein the fan is rotatably connected to the ultrasonic humidifier by a handle to allow adjustment of the position of the fan.

17. The ultrasonic humidifier of claim 12, comprising:
a second fan disposed at a bottom portion of the ultrasonic humidifier, wherein the second fan is configured to generate a second air flow to move the mist of water droplets generated by the ultrasonic transducer from the chamber toward the outlet along the tube.

18. A method for regulating a humidity in an environment using a humidifier, the method comprising:
providing a supply of water in a chamber of the humidifier;
generating a mist of water droplets from the supply of water in the chamber using an ultrasound transducer;
directing the mist of water droplets from the chamber to the environment exterior to the humidifier through an outlet of the humidifier; and
accelerating the mist of water droplets flowing out from the outlet using a forced air flow generated by a mist accelerator disposed in proximity to the outlet.

19. The method of claim 18, wherein accelerating the mist of water droplets comprises:
accelerating the mist of water droplets flowing out from the outlet using the forced air flow by drawing the mist toward the mist accelerator or pushing the mist away from the mist accelerator.

20. The method of claim 18, comprising:
detecting, by a humidity sensor, a humidity level in the environment;
generating, by the humidity sensor, a signal indicating the humidity level;
receiving, by a controller communicatively coupled to the humidity sensor, the signal;
determining, by the controller, whether the humidity level reaches a threshold based on the signal; and
controlling, by the controller, the mist accelerator to adjust the forced air flow based on the determination.
